(19) United States
(12) Patent Application Publication
(10) Pub. No.: US 2008/0081235 A1
(43) Pub. Date: Apr. 3, 2008

(54) Fuel cell system

(76) Inventors: Kenji Yamaga, Hitachi (JP); Hironori Sasaki, Hitachi (JP); Katsunori Nishimura, Hitachiota (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/698,110

(22) Filed: Jan. 26, 2007

(30) Foreign Application Priority Data
Sep. 28, 2006 (JP) 2006-263724

(51) Int. Cl. H01M 8/04

(52) U.S. Cl. 429/23; 429/22

(57) ABSTRACT

A fuel cell system having a fuel cell 1, a load 8 connected to the output line of the fuel cell 1 and a control apparatus 20 for controlling an amount of current flowing to the load 8, wherein a stopping state for stopping the fuel cell system includes a first stage stopping state for stopping while remaining hydrogen in the hydrogen line and a second stage stopping state for stopping substituting the hydrogen line with air, and transfers to the second stage stopping state by way of the first stage stopping state.

### CLAIM OF PRIORITY

The present application claims priority from Japanese application serial No. 2006-263724, filed on Sep. 28, 2006, the contents of which is hereby incorporated by reference into this application.

### BACKGROUND OF THE INVENTION

1. Field of the Invention

The present invention relates to a power generation system using a fuel cell.

2. Prior Art

A fuel cell is an electrochemical device for converting the energy of a fuel directly to electric energy by electrochemical reaction of the fuel cell. The fuel cell is generally classified depending on charge carriers to be used into a phosphate fuel cell, a molten carbonate fuel cell, a solid oxide fuel cell, a solid polymer fuel cell (hereinafter simply referred to as PEFC), and an alkali fuel cell.

In each type of the fuel cells, since PEFC can generate power at high current density and can be operated at a relatively low temperature, PEFC has been expected for various application uses including power sources for mobile equipment sources.

A fuel cell conducts power generation by using a hydrogen gas. When it is intended to be started, since the power generation can not be initiated, a hydrogen concentration has to be increased in a case where the hydrogen concentration of a hydrogen line in the cell is low. In this case, a purge method of driving out a gas in the line by utilizing the supply pressure of hydrogen has generally been used.

Further, during stopping of a fuel cell system, when a load is disconnected from the cell, it shows an open circuit voltage (OCV) and the voltage increases higher than that during power generation. Since the aforementioned state promotes deterioration of a catalyst or electrolyte in the cell, it is not preferred to leave the fuel cell system for a long time. Accordingly, as a method for reducing the cell voltage, there is a method of introducing air to the hydrogen line, thereby increasing the potential on a hydrogen electrode to the same level as the potential on an air electrode to approach the cell voltage substantially to 0. In this case, deterioration of the catalyst or the electrolyte due to the OCV state is scarcely caused.
Patent Document 1 discloses a method of stopping the starting of a fuel cell.
Patent Document 1: Japanese Patent Application Laid-open publication No. 2004-253220.

### SUMMARY OF THE INVENTION

However, in the operation method of frequently conducting starting and stopping, since the number of cycles of purging hydrogen in the hydrogen line and releasing the hydrogen to the outside thereof is increased, loss of hydrogen not usable for the power generation is increased and the power generation efficiency is deteriorated. Further, the release of hydrogen to the outside has also resulted in a deterioration of safety in the surrounding environment.

The object of the present invention is to provide a fuel cell system for increasing the power generation efficiency and ensuring high safety by reducing the release of hydrogen to the outside in accordance with starting and stopping of the operation.

For solving the aforementioned problems, the present invention provides a fuel cell system having a stopping state for stopping the fuel cell system which includes a first stage stopping state for stopping thereof by reducing a stack voltage while remaining hydrogen at a pressure equal with that in the power generation state in a hydrogen line and a second stage stopping state for stopping thereof substituting the hydrogen in the hydrogen line with air, and transfers to the second stage stopping state by way of the first stage stopping state.

Further, the present invention provides a fuel cell system in which control apparatus judges whether the time after transfer to the first stage stopping state, cell voltage, gas pressure in the cell, and cell temperature exceed predetermined values and transfers the stopping state for the fuel cell system from the first stage stopping state to the second stage stopping state.

Furthermore, the present invention provides a fuel cell system in which determination of hydrogen purge for increasing hydrogen concentration in the hydrogen line upon starting of the fuel cell system is judged by the control apparatus depending on the stopping stage, cell voltage, time of lapse, and pressure in the fuel cell.

According to the present invention, a fuel cell system for increasing the power generation efficiency and ensuring high safety by reducing the release of hydrogen to the outside in accordance with starting and stopping of the operation.

### BRIEF DESCRIPTION OF THE DRAWINGS

FIG. 1 schematically shows an embodiment of fuel cell system in the present invention;

FIG. 2 schematically shows a comparative example of fuel cell system in the present invention;

FIG. 3 shows a graph of the consumption amount of hydrogen in a starting and stopping test of the embodiment and the comparative example in the present invention; and

FIG. 4 shows a table comparing the starting time and the stopping time of the embodiment and the comparative example in the present invention.

### DETAILED DESCRIPTION OF THE PREFERRED EMBODIMENTS

Preferred embodiments of the invention are shown below.

### Embodiment

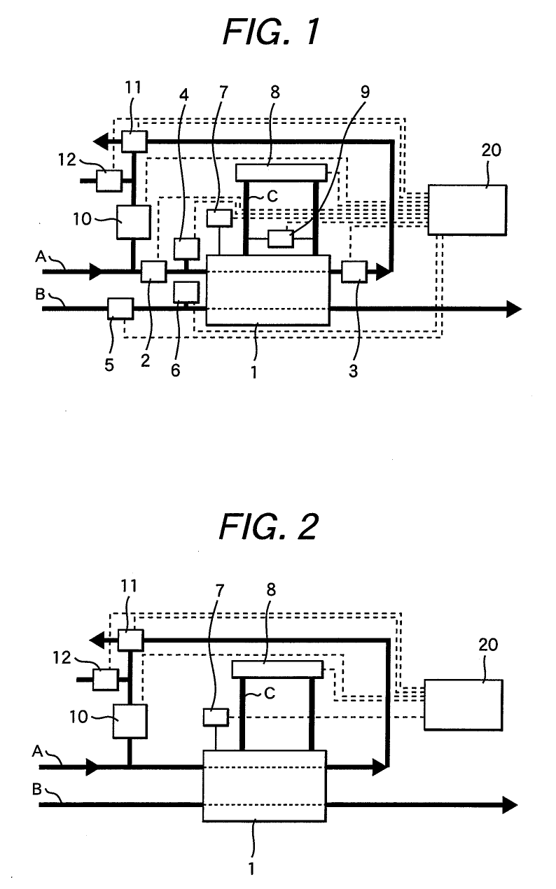

FIG. 1 schematically shows an embodiment of fuel cell system in the present invention. A basic constitution of a power generation system includes an electrode electrolyte membrane formed by integrating a perfluorocarbon sulfonic acid type electrolyte membrane and an electrode comprising a catalyst supporting platinum particles on a carbon support as a main ingredient as a center, a cathode diffusion layer and an anode diffusion layer made of carbon paper with the water repellent property be controlled by dispersing polytetrafluoroethylene (PTFE) on the surface thereof arranged on the surface and the rear face thereof and metal separators further disposed on both sides thereof. A fuel cell stack 1 was manufactured by combining 120 cells of the power generation cells and 60 cells of the cooling cells for reducing the cell temperature by flowing coolants therethrough.

A hydrogen line A for supplying and discharging hydrogen is connected to the fuel cell stack 1 provided with a temperature sensor 7 and a hydrogen inlet valve 2, a hydrogen exit valve 3, a hydrogen pressure sensor 4, a hydrogen pump 10, a hydrogen purge valve 11, an air introduction valve 12 are provided in the hydrogen line A. In the same manner, an air line B for supplying and discharging air is connected to the fuel cell stack 1 and an air inlet valve 5 and an air pressure sensor 6 are provided in the air line B. A load 8 such as a motor or a battery is connected to the power line C of the fuel cell stack 1 and, further, a small controlling load 9 is connected to the power line C. While heat is generated upon power generation of the fuel cell and a cooling line for cooling the fuel cell is usually mounted, this is not illustrated in this embodiment. Information from the sensors are transmitted to a control apparatus 20 and instructions judged in the control apparatus 20 are transmitted to each of auxiliary equipment to control the operation thereof.

A system starting method by using this embodiment of the fuel cell system is to be described. The switch for the small controlling load 9 connected with the fuel cell stack 1 is turned ON. This is for reducing the voltage in the OCV state by flowing a current to the small controlling load 9 in a state where the reaction gas is supplied to the fuel cell, thereby protecting the cell constituent materials such as the catalyst or the electrolyte.

Then, for supplying the reaction gas to the fuel cell, the hydrogen inlet valve 2 and the hydrogen exit valve 3 are put to an open state and a predetermined amount of hydrogen is supplied to the fuel cell stack 1 from a hydrogen reservoir connected with the hydrogen line A. Substantially at the same time, the air inlet valve 5 on the air line B is opened and a predetermined amount of air is supplied to the fuel cell stack 1 from an air supply blower connected with the air line B. For the hydrogen gas discharged from the fuel cell, a hydrogen gas at a high concentration is discharged. Therefore, the discharged hydrogen gas is boosted by the hydrogen pump 10 and supplied into the fuel cell inlet portion for supplying the discharged hydrogen gas again to the fuel cell stack 1.

In the hydrogen circulating line A, in a case where air is present upon starting, even when hydrogen is supplied, the hydrogen concentration in the hydrogen circulating line A does not reach 100%. Then, the hydrogen purge valve 11 is put to an open state for a short time in a state of supplying hydrogen to drive off air with hydrogen. According to this operation, the hydrogen concentration in the hydrogen line A reaches substantially 100% to complete the preparation for the power generation by the fuel cell.

Then, by operating the load 8, a current is taken out of the fuel cell. In this case, since the current flows also to the small controlling load 9, it is necessary to control such that the current value for the total flowing to the load 8 and the small controlling load 9 is below the maximum setting current for the fuel cell. In a case where the flow of the current to the load 8 can be confirmed and there is no abnormality in the state of the cell and the operation of the auxiliary equipment, the switch for the small controlling load 9 is turned OFF to conduct electric disconnection. Afterward, for conducting power generation from the fuel cell stack 1 in accordance with the amount of power required for the load, the amount of hydrogen supplied, the amount of air supplied, the amount of hydrogen pump operation, the amount of heat dissipation in the cooling line and the operation of each auxiliary equipment is controlled based on the instruction from the control apparatus 20.

In the same manner, a system stopping method by using this embodiment of the fuel cell system is shown below. The small controlling load 9 is turned ON. In this case, since the current flows also to the load 8, the load 8 is previously adjusted such that the maximum setting current of the fuel cell stack 1 is not exceeded. Then, the load 8 is disconnected electrically. The air blower is stopped and the air inlet valve 5 is closed. When it is confirmed that the cell voltage is decreased to 6 V or lower, supply of hydrogen is stopped, the hydrogen inlet valve 2 and the hydrogen exit valve 3 are closed, and the hydrogen pump 10 is stopped. After confirming that the cell voltage is at about 0 V, the small controlling load 9 is turned OFF. The operation of the cooling line is continued or stopped as required. This stopping state is the first stage stopping state. The small controlling load 9 may be left in the ON state as it is. According to this topping method, the stack voltage can be decreased without depressurizing the hydrogen line A and the air line B.

While the details for the principle of voltage decreasing are now under examination, since there is no change in the hydrogen electrode potential, it has been found so far that the potential of the air electrode is decreased. It is considered that since the electrode reaction proceeds in a state not supplying air, water as a reaction product functions as a material for suppressing the reaction between the electrode catalyst and air to decrease the potential of the air electrode.

Then, the starting method from the first stage stopping state is shown below. In a case where the small controlling load 9 is in the OFF state, it is turned to the ON state. In the first stage stopping state, since hydrogen in the hydrogen line is kept at a pressure equal with that in the power generation state and the hydrogen concentration is substantially 100% excluding water, a purging operation for increasing the hydrogen concentration is not necessary. Accordingly, hydrogen is circulated by putting the hydrogen inlet valve 2 and the hydrogen exit valve 3 into the open state, supplying hydrogen to the fuel cell stack 1 and operating the hydrogen pump 10. Substantially at the same time, the air inlet valve 5 is put to an open state and the air blower is operated to supply air to the fuel cell stack 1. Subsequent procedures are identical with those in the usual starting method. Upon initiation of starting, the control apparatus 20 can unify the information such as present stage of the stopping state, cell voltage, elapse of time after stopping, pressure in the cell, and the cell temperature, and judge whether the purge for the gas substitution in the hydrogen line A is conducted or not.

Since this starting method conducts starting from the state where hydrogen remains in the hydrogen line A, operation of increasing the hydrogen concentration in the hydrogen line A is not necessary and it is expected to be advantageous in view of the shortening of the starting time, insurance for safety, improvement of the power generation efficiency, etc.

However, when long time stopping is conducted in the first stage stopping state, the cell may possibly become instable. Since it is considered for this stopping method that water of formation suppresses the electrochemical reaction between the catalyst and the air on the air electrode, it may be a possibility that water is localized with lapse of a long time or decreased due to evaporation to result in decrease of the reaction suppressing effect and abruptly increase the cell voltage. In a case where the cell is left in a state near the OCV voltage, deterioration of the electrode catalyst or the electrolyte material is promoted to damage the cell. Even when the small controlling load 9, etc. is in the ON state, when current flows suddenly, it may be considered, for example, abnormal heat generation in a case where a heater is assumed, or overcharging in a case where a cell is assumed as the small controlling load 9. Accordingly, it is previously programmed such that the state of the cell is recognized by various kinds of information and, in a case where abnormalities are detected, the state is transferred from the first stage stopping state to the second stage stopping state capable of coping with long time stopping.

Operation accompanying the transition from the first stage stopping state to the second stage stopping state is as described below. From the first stage stopping state, all the hydrogen purge valve 11, the air introduction valve 12, the hydrogen inlet valve 2, and the hydrogen exit valve 3 are put to the open state, and the hydrogen pump 10 is operated. Since the hydrogen purge valve 11 is a three-way valve, the gas in the line A boosted by the hydrogen pump 10 is discharged without backflow. On the other hand, for compensating the negative pressure due to operation of the hydrogen pump 10, air out of the system is introduced passing through the air introduction valve 12 into the hydrogen line A, and the hydrogen concentration is decreased. With these operations described above, the potential on the hydrogen electrode is substantially at the same level as the potential on the air electrode and the cell voltage becomes 0 V. Further, in this state, since the atmosphere in the cell does not change even when it is left for a long time, it goes stably.

The transfer of the stopping state is judged by the control apparatus 20. The control apparatus 20 monitors information such as the temperature of the cell, cell voltage, and the gas pressure in the cell and, in a case where the value detected by each of the sensors exceeds a predetermined value, the control apparatus 20 judges that the cell is in an unstable state and conducts a transfer from the first stage stopping state to the second stage stopping state. Further, the control apparatus 20 counts the lapse of time after the first stage stopping state and in a case where it exceeds a predetermined time, it may also conduct the transfer of the stopping state.

In this embodiment, in a case where the voltage of the cell increases to 0.2V or higher per 1 cell, in a case where the cell temperature changes from 50° C. or lower to 50° C. or higher, in a case where the gage pressure in the hydrogen line A goes to 0 kPa or lower, or in a case where one hour or more has been lapsed after transfer to the first stage stopping state in the first stage stopping state, it automatically transfers to the second stage stopping state. This is due to the respective reasons for suppressing degradation of cell members due to high potential, avoiding oxidation reaction of the hydrogen gas due to abnormal heat generation thereby ensuring safety, suppressing degradation of the seal material and electrolyte membrane due to increase in the differential pressure, ensuring the system stopping time, etc.

Then, the starting and stopping method in a case of using a comparative example of fuel cell system in the present invention is shown below. The system constitution is shown in FIG. 2. While the constitution of the system is substantially identical with that of the aforementioned embodiment, the hydrogen inlet valve, the hydrogen exit valve, the hydrogen pressure sensor, the air inlet valve, the air pressure sensor, and the small controlling load are omitted.

The starting method in the comparative example is shown below. For supplying a reaction gas to a fuel cell, a predetermined amount of hydrogen is supplied from a hydrogen reservoir connected to a hydrogen line A. Substantially at the same time, a predetermined amount of air is supplied from an air supply blower connected with an air line B to a fuel cell stack 1. For the hydrogen gas discharged from the fuel cell, a hydrogen gas at a high concentration is discharged. Therefore, the discharged hydrogen gas is boosted by the hydrogen pump 10 and supplied into the fuel cell inlet portion for supplying the discharged hydrogen gas again to the fuel cell stack 1.

In the hydrogen circulating line A, in a case where air is present upon starting, even when hydrogen is supplied, the hydrogen concentration in the hydrogen circulating line A does not reach 100%. Then, the hydrogen purge valve 11 is put to an open state for a short time in a state of supplying hydrogen to drive off air with hydrogen. According to this operation, the hydrogen concentration in the hydrogen line A reaches substantially 100% to complete the preparation for the power generation by the fuel cell. Then, by operating the load 8, a current is taken out of the fuel cell. Afterward, for conducting power generation of the fuel cell stack 1 in accordance with the amount of power required for the load, the hydrogen supply amount, the air supply amount, the hydrogen operation amount, the cooling line heat dissipation amount, and the operation of each auxiliary equipment are controlled based on the judging instruction of the control apparatus 20.

Then, the stopping method in a case of using the comparative example of fuel cell system to be described below. The load 8 connected so far with the fuel cell stack 1 is electrically disconnected and the supply of air and hydrogen are stopped. Then, the hydrogen purge valve 11 and the air introduction valve 12 are put to the open state. Then, air outside of the system is introduced into the hydrogen line A to decrease the hydrogen concentration. With the operations described above, the potential on the hydrogen electrode is substantially at the same level as the potential on the air electrode and the cell voltage becomes 0 V. Afterward, the operation of auxiliary equipment is stopped. The operation of the cooling line is continued or stopped as required.

The content of a starting and stopping continuous test conducted in the present embodiment and the comparative example are shown below. Within 2 min after starting from the stopping state, the operation of the fuel cell system is transferred to a rated power generation state and the rated power generation was conducted as it was for 5 min. Afterward, the operation of the fuel cell system was transferred to the stopping state within 2 min, and the stopping state was maintained as it was for 10 min. This was defined as one cycle of starting and stopping operation. The starting and stopping operation was conducted for 300 cycles in total and the amount of hydrogen consumed during the starting and stopping operation was compared. The amount of hydrogen consumed during the rated power generation was calculated based on the amount of power generation and a corresponding amount was decreased previously.

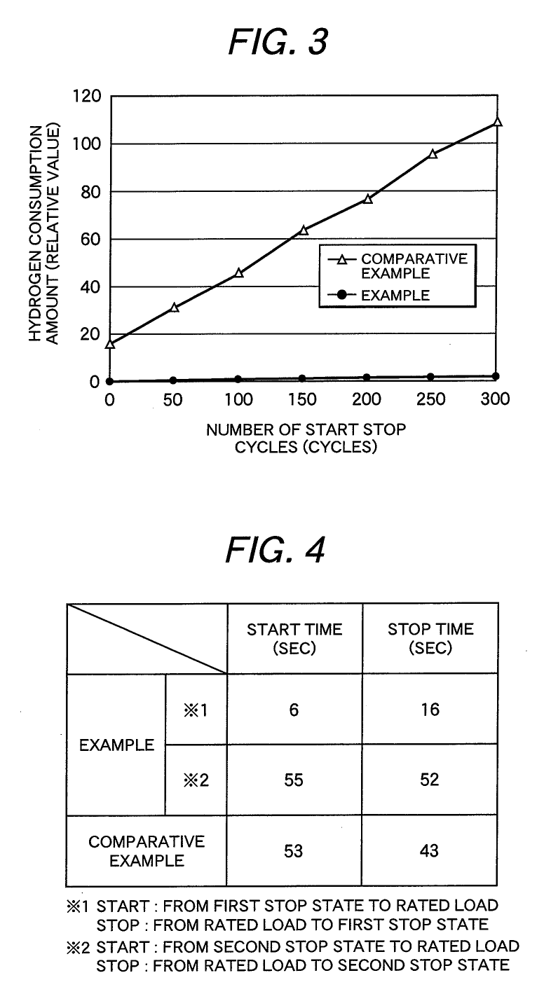

The result of the starting and stopping continuous test is shown in FIG. 3. In FIG. 3, the consumption amount of hydrogen upon starting and stopping test was decreased in the present embodiment of fuel cell system to about 1/60 compared with that in the comparative example. In the present embodiment, this is because the gas substitution operation in the hydrogen line can be saved upon starting and stopping operation by setting the stopping state into the two stages and adopting the first stage stopping state capable of stopping while remaining the hydrogen gas as it is in the hydrogen line and, as a result, the amount of hydrogen consumed by purging was decreased greatly. Accordingly, since hydrogen as the fuel gas can be used with no or small loss for the power generation, power generation efficiency can be improved.

FIG. 4 compares the starting time and the stopping time between the present embodiment and the comparative example of fuel cell system. In the present embodiment shown in FIG. 4, the starting time from the first stage stopping state, or the stopping time to the first stage stopping state is greatly shortened compared with those in the comparative example. This is because substitution with hydrogen in the hydrogen line A is not necessary with the same reasons as described above. Starting and stopping from the second stage stopping state requires more time than the starting and stopping from the first stage stopping state, but it can be confirmed that this is still at a level substantially equivalent with that in the comparative example.

As described above, In the fuel cell system of the present invention, the stopping method is divided into two stages and, further, a method of stopping while remaining hydrogen as it is in the hydrogen line is adopted in the first stage stopping state, as a result, the amount of discharged hydrogen from the hydrogen line can be decreased greatly upon re-starting. Accordingly, it is possible to improve the power generation efficiency, improve the safety, shorten the starting time, and shorten the stopping time for the fuel cell power generation system.

What is claimed is:

1. A fuel cell system having a fuel cell, a hydrogen line for supplying and discharging hydrogen to and from the fuel cell, a hydrogen inlet valve disposed to the inlet portion of the fuel cell in the hydrogen line, a hydrogen exit valve disposed to the exit portion of the fuel cell in the hydrogen line, a hydrogen pressure sensor disposed to the inlet portion of the fuel cell in the hydrogen line, an air line for supplying and discharging air to and from the fuel cell, an air inlet valve disposed to the inlet portion of the fuel cell in the air line, an air pressure sensor disposed to the inlet portion of the fuel cell in the air line, a temperature sensor for measuring the temperature of the fuel cell, a load and a small adjusting load connected to the output line of the fuel cell, and a control apparatus for controlling the operation of auxiliary equipment such as sensors and valves and an amount of current flowing to the loads, wherein a stopping state for stopping the fuel cell system includes a first stage stopping state for stopping the fuel cell system while remaining hydrogen in the hydrogen line and a second stage stopping state for stopping the fuel cell system substituting the hydrogen line with air, and transfers to the second stage stopping state by way of the first stage stopping state.

2. A fuel cell system according to claim 1, wherein the control apparatus judges whether the time after transfer to the first stage stopping state, cell voltage, gas pressure in the cell, and cell temperature exceed predetermined values and transfers the stopping state for the fuel cell system from the first stage stopping state to the second stage stopping state.

3. A fuel cell system according to claim 1, wherein determination of hydrogen purge for increasing hydrogen concentration in the hydrogen line upon starting of the fuel cell system is judged by the control apparatus depending on the stopping stage, cell voltage, time of lapse, and pressure in the fuel cell.

4. A fuel cell system according to claim 2, wherein determination of hydrogen purge for increasing the hydrogen concentration in the hydrogen line upon starting of the fuel cell system is judged by the control apparatus depending on the stopping stage, cell voltage, time of lapse, and pressure in the cell.
